(19) United States
(12) Patent Application Publication
(10) Pub. No.: US 2024/0323694 A1
(43) Pub. Date: Sep. 26, 2024

(54) Managing A Non-Acknowledgement Message (NACK) Attack

(71) Applicant: QUALCOMM Incorporated, San Diego, CA (US)

(72) Inventors: Soumya DAS, San Diego, CA (US); Sean Vincent MASCHUE, Encinitas, CA (US); Mohammad NEKOUI, San Diego, CA (US)

(21) Appl. No.: 18/189,242

(22) Filed: Mar. 24, 2023

(51) Int. Cl. H04W 12/122; H04W 12/00

(52) U.S. Cl. CPC H04W 12/122; H04W 12/009

(57) ABSTRACT

Various embodiments include methods and computing devices implementing such methods for detecting and responding to a non-acknowledgment message (NACK) attack. In some embodiments, a device vehicle processing system may perform an operation to determine whether a NACK attacker is present in response to a quantity of NACK messages received within a time interval exceeding a threshold quantity that is based on a vehicle communication environment proximate to the vehicle. The vehicle processing system may perform an operation to mitigate adverse effects of NACK messages received from the NACK attacker in response to determining that the NACK attacker is present.

### BACKGROUND

Message retransmissions of wireless communication packets enables accurate communication of information in environments in which such wireless signals may be lost, corrupted, or incompletely received. In some implementations, a transmitting device may send information packets two, three, or more times to enable a receiving device to receive the information. Even if portions of the information are lost in transmission, receiving multiple copies of the information may enable the receiving device to reassemble or otherwise recover the transmitted information.

However, retransmission mechanisms may be subject to attack. For example, a malicious actor could transmit a retransmission request that purports to be a legitimate request that the transmitting device to retransmit a message, but is in fact is a false or fake retransmission request. In this manner, the attacker attempts to induce the transmitting device to transmit unnecessary retransmissions, which may increase network congestion, and also may prevent the transmitting device from receiving important information from legitimate devices or from the communication network.

### SUMMARY

Various aspects include methods that may be performed by a computing device for detecting and responding to false or fake retransmission requests. Some aspects may be particularly useful in vehicle-to-vehicle and vehicle-to-everything (V2X) communications for detecting and responding to a non-acknowledgement message (NACK) attack. Such aspects may include a vehicle processing system performing an operation to determine whether a NACK attacker is present in response to a quantity of NACK messages received within a time interval exceeding a threshold quantity that is based on a vehicle communication environment proximate to the vehicle, and performing an operation to mitigate adverse effects of NACK messages received from the NACK attacker in response to determining that the NACK attacker is present.

In some aspects, the threshold quantity may be based on a density of second vehicles proximate to the vehicle. In some aspects, the quantity of NACK messages received within the time interval may include a quantity of NACK messages received within a predetermined number of transport blocks (TBs). In some aspects, the threshold quantity may be based on a minimum communications range (MCR) encoded in a transmission from the vehicle.

In some aspects, performing an operation to determine whether a NACK attacker is present may include reducing an MCR that was encoded in a transmission from the vehicle retransmitting the first transmission using the reduced MCR, and confirming that the NACK attacker is present in response to receiving a NACK message responsive to the retransmission. In some aspects, reducing the MCR that was encoded in a transmission from the vehicle may include reducing the MCR by a first amount in response to determining that a channel busy ratio (CBR) meets a CBR threshold, and reducing the MCR by a second amount that is less than the first amount in response to determining that the CBR does not meet the CBR threshold.

In some aspects, performing an operation to determine whether a NACK attacker is present may include transmitting a sufficient number of retransmissions of a message to enable the vehicle processing system to determine that a next received NACK message is an illegitimate NACK message. Some aspects may further include identifying a direction from the vehicle to the NACK attacker based on an angle of arrival of the illegitimate NACK message. In some aspects, retransmissions of the message may be transmitted with one or both of a smaller encoded MCR than the message or a more robust modulation and coding scheme (MCS).

In some aspects, performing an operation to determine whether a NACK attacker is present may include including in one or more retransmissions of a message sent in response to received NACK messages a probe transport block that is configured to be smaller than a data-carrying transport block.

Further aspects include a vehicle processing system including a memory and a processor configured to perform operations of any of the methods summarized above. Further aspects may include a vehicle processing system having various means for performing functions corresponding to any of the methods summarized above. Further aspects may include a non-transitory processor-readable storage medium having stored thereon processor-executable instructions configured to cause a processor of a vehicle processing system to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing various embodiments.

FIG. 1B is a system block diagram illustrating an example disaggregated base station architecture suitable for implementing various embodiments.

FIG. 2 is a component diagram of an example vehicle V2X processing system suitable for implementing various embodiments.

FIG. 3A is a block diagram illustrating components of a system on chip for use in a vehicle V2X processing system in accordance with various embodiments.

FIG. 3B is a component block diagram illustrating elements of a vehicle V2X processing system configured in accordance with various embodiments.

FIGS. 4A and 4B are conceptual diagrams illustrating methods for managing a NACK in accordance with various embodiments.

FIG. 5A is a process flow diagram of an example method performed by a processor of a vehicle processing system for managing a NACK attack in accordance with various embodiments.

FIG. 5B is a process flow diagram of example operations that may be performed by a processor of a vehicle processing system as part of the method for managing a NACK attack in accordance with various embodiments.

FIG. 5C is a process flow diagram of example operations that may be performed by a processor of a vehicle processing system as part of the method for managing a NACK attack in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices (e.g., vehicle processing systems) implementing the methods, for detecting the presence of an attacker that is sending spurious or false non-acknowledgment (NACK) messages misbehavior (referred to herein as a “NACK attack”) to cause a transmitting computing device to send unnecessary retransmissions. A NACK attack that causes vehicle systems to send unnecessary retransmissions may result in a number of adverse effects on communications and the use of data shared between devices (e.g., vehicle processing systems), such as increasing network congestion and prevent computing devices, such as vehicles, from receiving operationally critical or safety critical information. Various embodiments enable computing devices, such as processing systems of vehicles equipped with vehicle-to-everything (V2X) communications equipment, to recognize when a NACK attack is occurring and respond by taking one or more actions to prevent, reduce or otherwise mitigate the adverse effects on communications and vehicle safety that otherwise could be caused by such an attack.

As used herein, the term “vehicle” refers generally to any of an automobile, motorcycle, truck, bus, train, boat, and any other type of vehicle V2X-capable system that may be configured to manage transmission of misbehavior reports.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Message retransmission in wireless communication systems enables accurate communication of information in environments in which the wireless signals conveying the information may be lost, corrupted, or incompletely received. Various communication systems may implement a variety of retransmission mechanisms. In some implementations, a receiver that is unable to decode a message from a sender may transmit a retransmission request, such as a non-acknowledgment (NACK) message.

In New Radio Vehicle-to-Everything (NR-V2X) connection-less groupcast, a NACK may be sent by a receiver device that is able to decode a signal received via a Physical Sidelink Control Channel (PSCCH), but is unable to decode a corresponding signal that is received via a Physical Side Link Shared Channel (PSSCH), if the receiver is located within a Minimum Communication Range (MCR). The MCR is a parameter that is encoded within a V2X message transmitted in a group communication (e.g., groupcast communications). The MCR indicates a range or radius from a transmitting computing device (e.g., a transmitting vehicle processing system) within which the transmitting computing device attempts to maintain a minimum quality of service (QOS). Computing devices that receive a signal or message from the transmitter may decode or extract the MCR. Receiving computing devices that are within the radius or range indicated by the MCR may respond to the transmitting computing device with acknowledgment (ACK) or NACK message. Receiving computing devices that are not within the MCR are configured to not send an ACK or NACK message to the transmitting computing device.

However, such retransmission mechanisms may be exploited by an attacker or bad actor. An attacker (referred to herein as a “NACK attacker”) may send spurious or illegitimate NACK messages to the transmitting computing device regardless of whether the attacker is within or beyond the MCR. Receiving an illegitimate NACK message can cause the transmitting computing device to unnecessarily retransmit a message, which can result in a variety of adverse effects. For example, such adverse effects may include unnecessary retransmissions consuming wireless communication resources and increasing network congestion. As another example of adverse effects of a NACK attack, sending too many unnecessary retransmissions may result in increased packet drops by or among other legitimate (i.e., non-attacker) computing devices (e.g., V2X-equipped vehicles) that have already received and decoded the message. As a further example of adverse effects of a NACK attack, in communication systems configured to use half-duplex communication (i.e., radios can either transmit or receive but not both simultaneously), such as groupcast communications, a computing device cannot receive incoming V2X messages while transmitting unnecessary retransmissions. In the case of V2X communications, this can lead to potentially dangerous conditions in which the transmitting computing device cannot receive vital information about other vehicles or the traffic environment. Thus, a NACK attack during groupcast communications can be highly disruptive of V2X communications.

For example, assuming a Physical Sidelink Feedback Channel (PSFCH) period of N=4 (in which the PSFCH conveys feedback such as NACK messages), even with a relatively low duty cycle of (2 symbols)/(4×14 symbols)=3.6%, a NACK attacker may disrupt communications among all legitimate computing devices (e.g., vehicles) in range.

Various embodiments enable a computing device to detect a NACK attack and to perform an operation to mitigate adverse effects of the detected NACK attack. In some embodiments, the computing device may receive (identify, determine, detect) a quantity of NACK messages received within a time interval that exceeds a threshold quantity (i.e., a set quantity of NACK messages) that is based on a communication environment proximate to the computing device. The interval within which NACK messages are tallied for detecting a NACK attack may be a time interval, a permitted communication interval, and communication opportunities allocated in the communication protocol. For example, in some embodiments the interval may be measured in terms of a predetermined number of transport blocks (TBs) and the computing device may detect a NACK attack by determining whether a quantity of NACK messages received within a predetermined number of TBs exceeds a threshold quantity of NACK messages. As another example, in some embodiments the interval may be measured in terms of a predetermined amount of time, and the computing device may detect a NACK attack by determining whether a quantity of NACK messages received within a predetermined period of time exceeds the threshold quantity of NACK messages.

Various embodiments may be particularly useful in V2X communication networks due to the safety critical functions of V2X communications and variability in circumstances that can surround a V2X-equipped vehicle. In such implementations, the threshold quantity may vary depending on various circumstances, including traffic conditions and communication settings. In some embodiments, the vehicle processing system may determine and/or adjust the threshold quantity based on the number of other vehicles (second vehicles) proximate to (in the vicinity of) the vehicle (e.g., traffic density). In some embodiments, the vehicle processing system may determine and/or adjust the threshold quantity based on the MCR used by the vehicle processing system when transmitting messages. In some embodiments, the vehicle processing system may determine and/or adjust the threshold quantity based on the modulation and coding scheme (MCS) used by the vehicle processing system when transmitting (and retransmitting) messages.

In some embodiments, a vehicle processing system may take an action to confirm whether a suspected NACK attacker is present. Such embodiments may reduce the likelihood of mistaking legitimate NACK messages as a NACK attack, avoiding taking mitigating actions when retransmissions are appropriate.

In some embodiments, a vehicle processing system may adjust MCR settings to confirm whether a suspected NACK attacker is present. For example, in response to recognizing that more NACK messages have been received than expected under the circumstances (i.e., more than the threshold quantity) the vehicle processing system may reduce the MCR that is encoded in transmissions, retransmit the indicated message (first transmission) including the reduced MCR, and determine that an NACK attacker is present in response to receiving another NACK that is responsive to the retransmission. In some embodiments, the vehicle processing system may repeat the operations of reducing the MCR and retransmitting with the reduced MCR to determine whether reducing the communication radius eliminates NACK requests. In such embodiments, the vehicle processing system may determine that the NACK attacker is present in response to receiving a NACK responsive to one or more of the retransmissions that are transmitted with a reduced, or iteratively reduced, MCR values. Since a legitimate vehicle that is outside the MCR should not NACK message, receiving a NACK message despite a sufficiently small MCR may enable the vehicle processing system to readily identify the presence of a NACK attacker.

In some embodiments, the vehicle processing system may vary an amount by which the vehicle processing system reduces the MCR based on a channel busy ratio (CBR). A CBR (or CBT (Channel Busy Time)) may indicate a channel load or level of congestion detected by the vehicle processing system. For example, a CBR may indicate a ratio between a time that a channel is detected as busy and a total observation time. CBR may be affected by a number of vehicles within a transmission range and/or the message or signal generation rates of such vehicles.

In some embodiments, the vehicle processing system may determine a CBR threshold based on detected communication conditions, or may obtain a CBR threshold from memory. When the CBR is low, the vehicle processing system may reduce the MCR more gradually (e.g., using smaller reduction intervals). When the CBR is high, the vehicle processing system may reduce the MCR using larger reduction intervals. In some embodiments, the vehicle processing system may reduce the MCR by a first amount in response to determining that the CBR meets a CBR threshold. The vehicle processing system may reduce the MCR by a second amount that is less than the first amount in response to determining that the CBR does not meet the CBR threshold.

In some embodiments, a vehicle processing system may adjust modulation and coding scheme (MCS) settings for retransmissions to confirm whether a suspected NACK attacker is present. For example, using a more robust MCS in retransmissions should enable legitimate recipients to receive and process the retransmitted message. Thus, continued reception of NACK requests for messages transmitted with increasingly robust MCS settings may confirm that a NACK attack is being conducted.

In some embodiments, a vehicle processing system may adjust the number of retransmission that are sent in response to NACK requests to confirm whether a suspected NACK attacker is present. In some embodiments, the vehicle processing system may transmit a sufficient number of retransmissions of a message to enable the vehicle processing system to determine that a next received NACK message is an illegitimate NACK message. For example, in most scenarios all or nearly our legitimate vehicles should be able to decode a message given a sufficient number of retransmissions even if legitimate vehicles are unable to decode an initially-transmitted message. As such, the vehicle processing system may determine that a NACK message received after a sufficient number of retransmissions is most likely an illegitimate NACK message, and the device that transmitted the illegitimate NACK message is most likely a NACK attacker.

In some embodiments, the vehicle processing system may determine a direction of the NACK attack. In some embodiments, the vehicle processing system may identify a direction from the vehicle to the NACK attacker based on an angle of arrival of the illegitimate NACK message. In some embodiments, the vehicle processing system may identify an angular segment or directional arc relative to the vehicle (e.g., a quadrant) in which the NACK attacker is present.

In various embodiments, the vehicle processing system may perform an operation to mitigate adverse effects of NACK messages received from the NACK attacker in response to determining that the NACK attacker is present.

In some embodiments, the vehicle processing system may ignore NACK messages originating from the identified direction of the NACK attacker, or NACK messages transmitted from the identified zone in which the NACK attacker is present.

In some embodiments, the vehicle processing system may reduce network congestion potentially caused by retransmissions by using probe messages that are configured to be smaller than data-carrying retransmitted messages. In some embodiments, the vehicle processing system may include in one or more retransmissions of a message in a probe transport block that is configured to be smaller than a data-carrying transport block.

Various embodiments improve the safety and efficiency of processing systems and communication systems by enabling computing devices to detect and/or identify NACK attacks and take appropriate action in response to detected NACK attacks. Various embodiments improve the safety and operation of systems in which such computing devices are deployed by enabling computing devices to reduce or eliminate the adverse effects that a NACK attack can have, such as reducing disruptions to communications that an attacker attempts to create through abuse of the retransmission process.

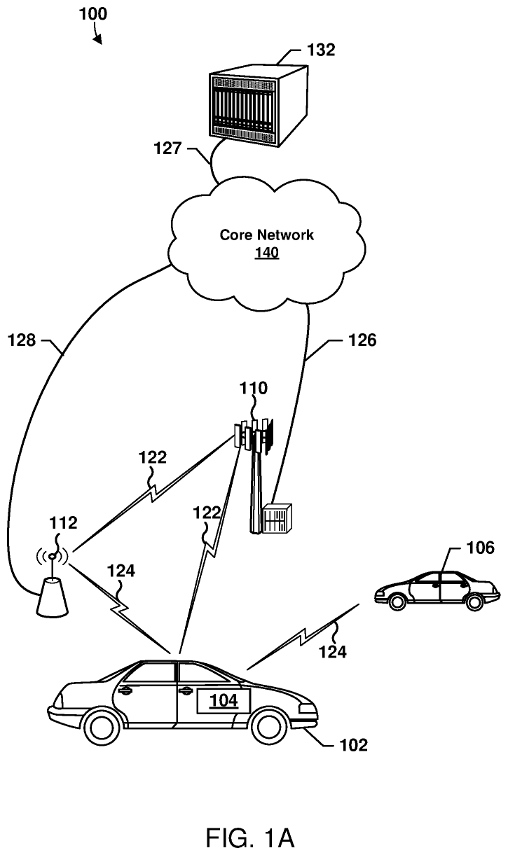

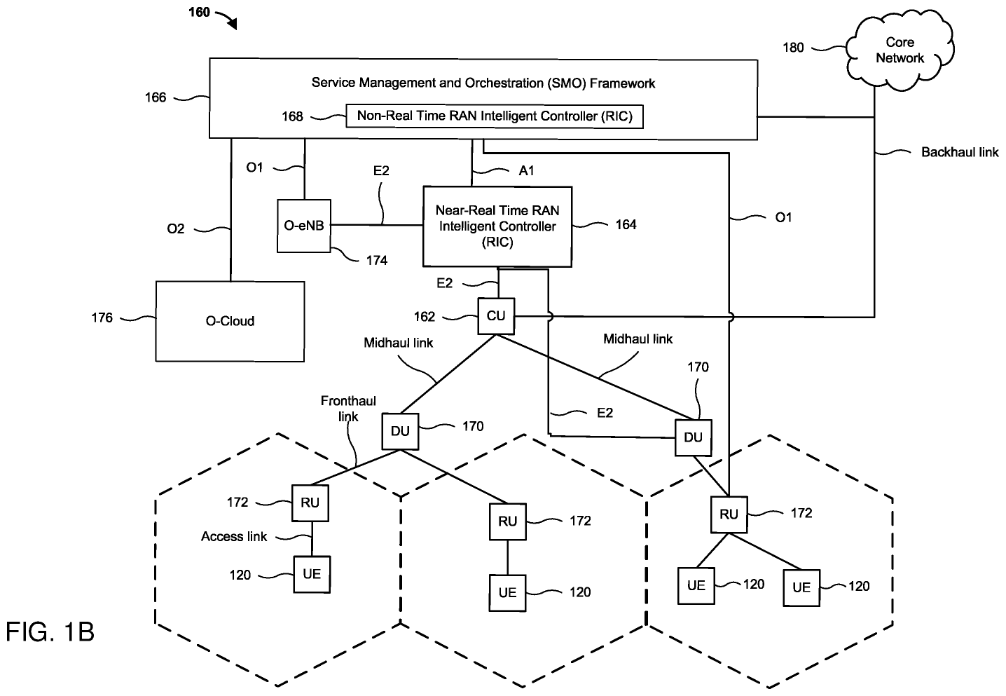

FIG. 1A is a system block diagram illustrating an example communication system 100 suitable for implementing the various embodiments. The communications system 100 include a 5G New Radio (NR) network, an intelligent transportation system (ITS) V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including vehicles 102 and 106 that may be equipped with a V2X processing system 104 that includes wireless communication capabilities. The base station 110 may communicate with a core network 140 over a wired communication link 126. The communications system 100 also may include roadside units 112 supporting V2X communications with vehicles 102 via V2X wireless communication links 124. The vehicles 102 and 106 may be configured to communicate via wireless communication 124. In some embodiments, the wireless communication 124 may include a wireless communication link. In some embodiments, the wireless communication 124 may represent a connection-less communication scheme, such as connection-less groupcast.

A base station 110 is a network element that communicates with wireless devices (e.g., a V2X processing system 104 of the vehicle 102) via a wireless communication link 122, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Roadside units 112 may communicate with the core network 140 via a wired or wireless communication link 128. Roadside units 112 may communicate via V2X wireless communication links 124 with V2X processing system-equipped vehicles 102 for downloading information useful for V2X processing system autonomous and semi-autonomous driving functions, and for receiving information such as misbehavior reports from the V2X processing system 104.

A Misbehavior Authority network computing device (MA) 132 may communicate with the core network 140 via a wired or wireless communication link 127. The MA 132 may receive misbehavior reports from the V2X processing system 104 as may be sent by the V2X processing system 104 from time to time.

Wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network (e.g., the communication system 100) according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a V2X processing system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit—User Plane (CU-UP)), control plane functionality (i.e., Central Unit—Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an 02 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

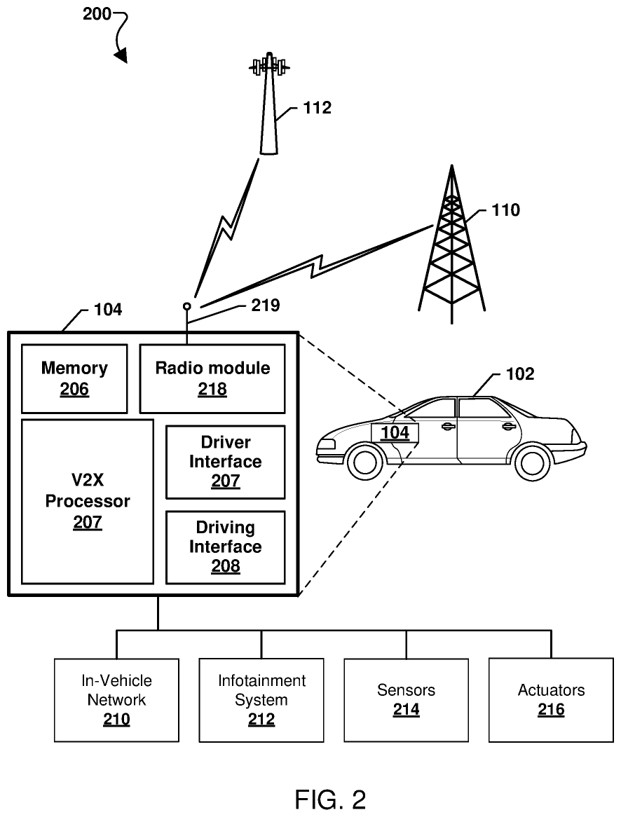

FIG. 2 is a component diagram of an example vehicle V2X processing system 200 suitable for implementing various embodiments. With reference to FIGS. 1A-2, the processing system 200 may include a vehicle 102 that includes a V2X processing system 104. The vehicle V2X processing system 104 may communicate with various systems and devices, such as an in-vehicle network 210, an infotainment system 212, various sensors 214, various actuators 216, and a radio module 218 coupled to an antenna 219. The vehicle V2X processing system 104 also may communicate with roadside units 112, cellular communication network base stations 110, and other external devices.

The V2X processing system 104 may include a processor 205, memory 206, an input module 207, an output module 208 and the radio module 218. The processor 205 may be coupled to the memory 206 (i.e., a non-transitory storage medium), and may be configured with processor-executable instructions stored in the memory 206 to perform operations of the methods according to various embodiments described herein. Also, the processor 205 may be coupled to the output module 208, which may control in-vehicle displays, and to the input module 207 to receive information from vehicle sensors as well as driver inputs.

The V2X processing system 104 may include a V2X antenna 219 coupled to the radio module 218 that is configured to communicate with one or more ITS participants (e.g., stations), a roadside unit 112, and a base station 110 or another suitable network access point. The V2X antenna 219 and radio module 218 may be configured to receive dynamic traffic flow feature information via vehicle-to-everything (V2X) communications. In various embodiments, the V2X processing system may receive information from a plurality of information sources, such as the in-vehicle network 210, infotainment system 212, various sensors 214, various actuators 216, and the radio module 218. The V2X processing system may be configured to perform autonomous or semi-autonomous driving functions using map data in addition to sensor data, as further described below.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network. Examples of vehicle sensors 214 include a location determining system (such as a Global Navigation Satellite Systems (GNSS) system, a camera, radar, lidar, ultrasonic sensors, infrared sensors, and other suitable sensor devices and systems. Examples of vehicle actuators 216 include various physical control systems such as for steering, brakes, engine operation, lights, directional signals, and the like.

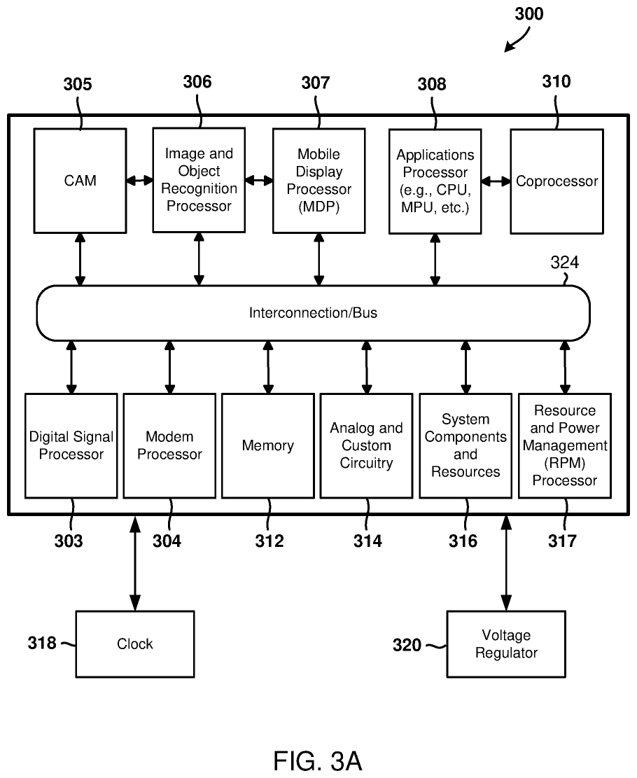

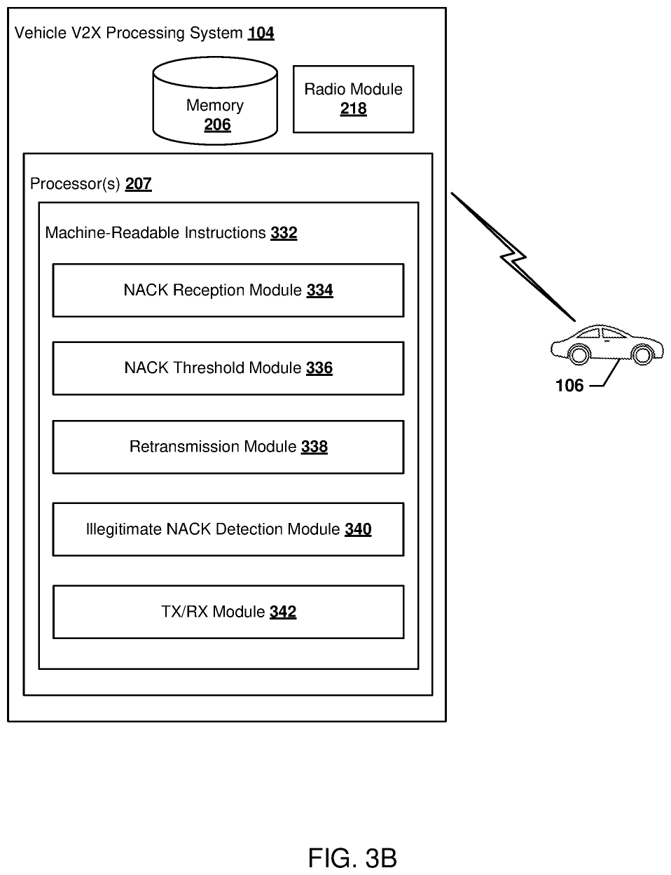

FIG. 3A is a block diagram illustrating an example components of a system on chip (SOC) 300 for use in a vehicle V2X processing system in accordance with various embodiments. With reference to FIGS. 1A-3A, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317.

Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras via the CAM 305 to recognize and/or identify other vehicles, and otherwise perform functions of the camera perception layer 224 as described. In some embodiments, the processor 306 may be configured to process radar or lidar data and perform functions of the radar and/or lidar perception layer 222 as described.

The system components and resources 316, analog and custom circuitry 314, and/or CAM 305 may include circuitry to interface with peripheral devices, such as cameras, radar, lidar, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, Global Positioning System (GPS) receivers, communications circuitry (e.g., Bluetooth®, WLAN, WiFi, etc.), and other well-known components of modern electronic devices.

FIG. 3B is a component block diagram illustrating elements of a vehicle V2X processing system 104 configured in accordance with various embodiments. With reference to FIGS. 1A-3B, the V2X processing system 104 of a vehicle (e.g., 102) may be configured to communicate with a roadside unit 112, a cellular network base station 110, and/or one or more other vehicles 12, 14, 16.

The vehicle V2X processing system 104 may include one or more processors 205, memory 206, a radio module 218, and other components. The vehicle processing system 104 may include a plurality of hardware, software, and/or firmware components operating together to provide the functionality attributed herein to the processor 205.

The memory 206 may include non-transitory storage media that electronically stores information. The electronic storage media of memory 206 may include one or both of system storage that is provided integrally (i.e., substantially non-removable) with the vehicle processing system 104 and/or removable storage that is removably connectable to the vehicle V2X processing system 104 via, for example, a port (e.g., a universal serial bus (USB) port, a firewire port, etc.) or a drive (e.g., a disk drive, etc.). In various embodiments, memory 206 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media.

The memory 206 may include one or more virtual storage resources (e.g., cloud storage, a virtual private network, and/or other virtual storage resources). Memory 206 may store software algorithms, information determined by processor(s) 205, information received from the one or more other vehicles 12, 14, 16, information received from the roadside unit 112, information received from the base station 110, and/or other information that enables the vehicle V2X processing system 104 to function as described herein.

The processor(s) 205 may include one of more local processors that may be configured to provide information processing capabilities in the vehicle V2X processing system 104. As such, the processor(s) 205 may include one or more of a digital processor, an analog processor, a digital circuit designed to process information, an analog circuit designed to process information, a state machine, and/or other mechanisms for electronically processing information. Although the processor(s) 205 is shown in FIG. 3B as a single entity, this is for illustrative purposes only. In some embodiments, the processor(s) 205 may include a plurality of processing units. These processing units may be physically located within the same device, or the processor(s) 205 may represent processing functionality of a plurality of devices distributed in the vehicle and operating in coordination.

The vehicle V2X processing system 104 may be configured by machine-readable instructions 332, which may include one or more instruction modules. The instruction modules may include computer program modules. In various embodiments, the instruction modules may include one or more of a NACK reception module 334, a NACK threshold module 336, a retransmission module 338, and illegitimate NACK detection module 340, a TX/RX module 342, and/or other modules.

The NACK reception module 334 may be configured to receive a NACK message from another vehicle (e.g., 106) via a signal received by the TX/RX module 342. The NACK reception module 334 may be configured to determine a direction from the vehicle V2X processing system 104 to a NACK attacker based on an angle of arrival of an illegitimate NACK message.

The NACK threshold module 336 may be configured to select or determine a threshold quantity of NACK message is based on a vehicle communication environment proximate to the vehicle (e.g., the vehicle V2X processing system 104). In some embodiments, the threshold quantity of NACK messages may be based on a density of second vehicles proximate to the vehicle. In some embodiments, the threshold quantity of NACK messages may be based on a minimum communications range (MCR) encoded in a transmission from the vehicle.

The retransmission module 338 may be configured to transmit one or more retransmissions of a message via the TX/RX module 342 in response to a NACK message received from another vehicle. The retransmission module 338 may be configured to reduce an MCR used in one or more retransmissions of a message. The retransmission module 338 may be configured to reduce the MCR by a first amount in response to determining that a CBR meets a CBR threshold, and may reduce the MCR by a second amount that is less than the first amount in response to determining that the CBR does not meet the CBR threshold.

The illegitimate NACK detection module 340 may be configured to perform an operation to determine whether a NACK attacker is present in response to a quantity of NACK messages received within a time interval exceeding a threshold quantity of NACK messages. In some embodiments, the quantity of NACK messages received within the time interval may include a quantity of NACK messages received within a predetermined number of transport blocks (TBs). The illegitimate NACK detection module 340 may be configured to determine that the NACK attacker is present in response to receiving a NACK message responsive to a retransmission. The retransmission module 338 may be configured to transmit one or more retransmissions of a message with one or both of a smaller encoded MCR or a more robust MCS. The retransmission module 338 may be configured to include in one or more retransmissions of a message sent in response to received NACK messages a probe transport block that is configured to be smaller than a data-carrying transport block.

The TX/RX module 342 may be configured to control the operations of communication devices of the vehicle processing system such as the radio module 218.

The processor(s) 207 may be configured to execute the modules 332-342 and/or other modules by software, hardware, firmware, some combination of software, hardware, and/or firmware, and/or other mechanisms for configuring processing capabilities on processor(s) 205.

The description of the functionality provided by the different modules 332-342 is for illustrative purposes, and is not intended to be limiting, as any of modules 332-342 may provide more or less functionality than is described. For example, one or more of modules 332-342 may be eliminated, and some or all of its functionality may be provided by other ones of modules 332-342. As another example, processor(s) 207 may be configured to execute one or more additional modules that may perform some or all of the functionality attributed below to one of modules 332-342.

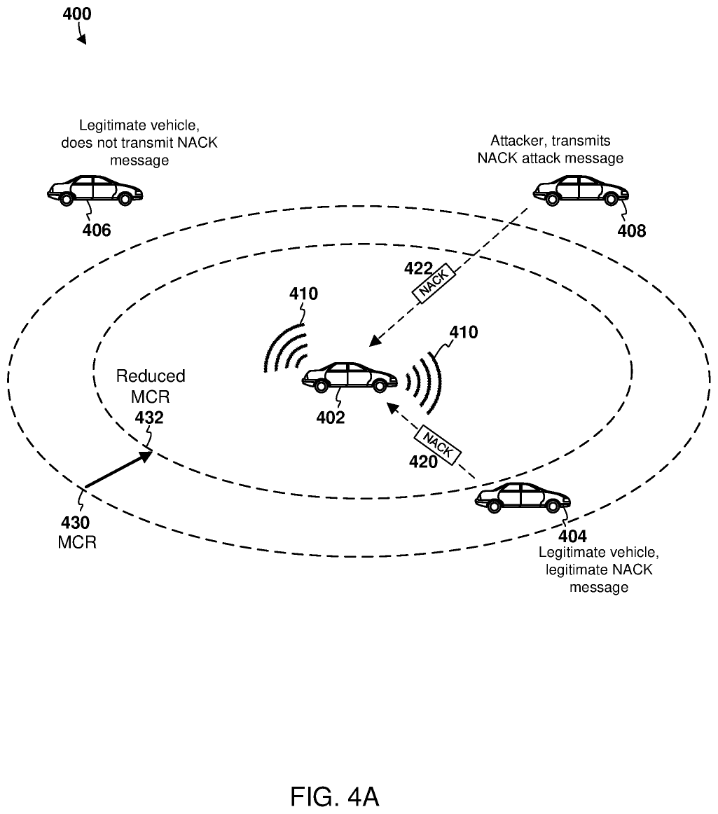

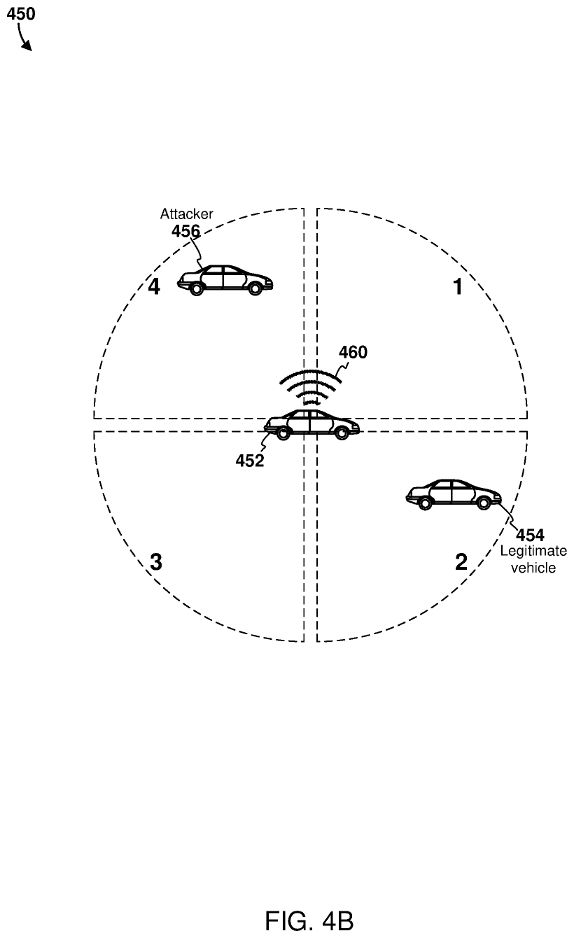

FIG. 4A is a conceptual diagram illustrating a method 400 for managing a NACK in accordance with various embodiments. With reference to FIGS. 1A-4A, a first vehicle 402 may transmit groupcast signals 410 that may be received by the vehicles 404, 406, and 408. In some embodiments, the groupcast signals 410 may include a control signal transmitted via a Physical Sidelink Control Channel (PSCCH), and a data message via a Physical Side Link Shared Channel (PSSCH). The groupcast signals 410 (e.g., PSCCH and/or PSSCH) may include an indication of a first MCR 430.

The vehicles 404, 406, and 408 may receive the groupcast signals 410. The vehicle 404 may be within the MCR 430. If the vehicle 404 is unable to decode the data message received from the vehicle 402, the vehicle 404 may transmit a NACK message 420 to the vehicle 402. In response to receiving the NACK message 420, the vehicle 402 may retransmit the data message via a groupcast signal. The vehicle 406 also may receive the groupcast signals 410. However, because the vehicle 406 is outside the MCR 430, the vehicle 406 will not transmit a NACK message (or an ACK message) to the vehicle 402.

An attacker vehicle 408 also may receive the groupcast signals 410. Regardless of whether the attacker vehicle 408 is able to successfully decode any message from the vehicle 402, the attacker vehicle 408 transmits a NACK message 422 to perpetuate a NACK attack. In response to receiving the NACK message 422, the vehicle 402 may retransmit the data message via groupcast signal. The attacker vehicle 408 typically will transmit the NACK message 422 whether it is within the MCR 430 or beyond the MCR 430.

The vehicle 402 may suspect the presence of NACK attacker 408. For example, the vehicle 402 may determine that, based on a vehicle communication environment proximate to the vehicle 402, quantity of NACK messages that the vehicle 402 receives within a time interval exceeds a threshold quantity of NACK messages.

Various aspects of the vehicle communication environment may affect whether a vehicle (e.g., 404) is able to receive and decode the message transmitted by the vehicle 402, which in turn may affect whether legitimate receiving vehicles transmit one or more NACK messages. For example, the vehicle 402 may determine a quantity of vehicles that are within the MCR 430 (e.g., vehicle 404). As another example, the vehicle 402 may determine one or more aspects of local RF conditions, such as a level of signal interference. As another example, the vehicle 402 may determine one or more aspects of communication channel conditions, such as a level of channel congestion.

Based on one or more aspects of the vehicle communication environment proximate to the vehicle 402, the vehicle 402 may determine, or may obtained from memory, a threshold quantity of NACK messages appropriate for the vehicle communication environment. The vehicle 402 may receive the NACK message 420 from the vehicle 404 and the NACK message 422 from the attacker vehicle 408. The vehicle 402 may determine that a quantity of NACK message received within a time interval exceeds the threshold quantity of NACK messages. In some embodiments, the vehicle 402 may determine that a quantity of NACK messages received within a predetermined number of transport blocks (TBs) exceeds a threshold quantity of NACK messages. In some embodiments, the vehicle 402 may determine that a quantity of NACK messages received within a predetermined period of time exceeds the threshold quantity of NACK messages.

The vehicle 402 may perform an operation to confirm whether a NACK attacker is present in response to the quantity of NACK messages received within a time interval exceeding the threshold quantity of NACK messages. In some embodiments, the vehicle 402 may reduce the MCR 430 to a reduced MCR 432, and may retransmit the data message using the reduced MCR 432. Because a legitimate vehicle 404 is located outside of or beyond the reduced MCR 432, even if the vehicle 404 is unable to decode the retransmitted data message, the vehicle 404 will not transmit another NACK message to the vehicle 402. However, the attacker vehicle 408 may transmit another NACK message 422 to the vehicle 402, regardless of the MCR 432. In some embodiments, in response to receiving the NACK message 422 that is responsive to the retransmission, the vehicle 402 may determine that a NACK attacker is present.

The vehicle 402 may perform an operation to mitigate adverse effects of NACK messages received from the NACK attacker in response to determining that the NACK attacker is present. For example, the vehicle 402 may ignore (disregard) and thus not retransmit messages in response to NACK messages that have been identified as originating from the attacker vehicle 408.

FIG. 4B is a conceptual diagram illustrating a method 450 for managing a NACK leveraging capabilities to determine the direction from which messages are received by a vehicle in accordance with various embodiments. With reference to FIGS. 1A-4B, a first vehicle 452 may transmit groupcast signals 460 that may be received by the vehicles 454 and 456. In some embodiments, the groupcast signals 460 may include a control signal transmitted via a Physical Sidelink Control Channel (PSCCH), and a data message via a Physical Side Link Shared Channel (PSSCH).

If the legitimate vehicle 454 is unable to decode a data message from the vehicle 452, the vehicle 454 may transmit a NACK message to the vehicle 452 requesting retransmission of the data message. In response to successfully decoding the data message, the legitimate vehicle 454 will not transmit a NACK message. The attacker vehicle 456 will transmit a NACK message regardless whether the data messages was decodable.

In some embodiments, the first vehicle 452 may be configured with two or more antennas, phased-array antennas, or other directional antenna configurations, that enable the vehicle processing system to determine the direction or directional arc from which an incoming NACK message is received, such as an angle of arrival. In some embodiments, the first vehicle 452 may identify angular zones, directional arcs, quadrants, or other directional subdivisions surrounding the vehicle. FIG. 4B illustrates four quadrants 1, 2, 3, and 4, but this is merely one example and not intended to be limiting. The first vehicle 452 may determine that a NACK message from the vehicle 454 originates from quadrant 2, and that a NACK message from the vehicle 456 originates from quadrant 4.

In some embodiments, the vehicle 452 may transmit a sufficient number of retransmissions of a message to enable the vehicle 452 to determine that a subsequently received (next received) NACK message is an illegitimate NACK message (an attack NACK message, a spurious NACK message) transmitted by the attacker vehicle 456, and thus that the vehicle 456 is an attacker. In some embodiments, the vehicle 452 may determine a sufficient number of retransmissions needed for an accurate assessment of whether a NACK message is an illegitimate NACK message based on one or more aspects of the vehicle communication environment. For example, the vehicle 452 may determine or select a threshold number of retransmissions based on one or more of: a quantity of vehicles in the communication environment; one or more aspects of local RF conditions, such as a level of signal interference; and/or one or more aspects of communication channel conditions, such as a level of channel congestion.

In some embodiments, as the vehicle 452 transmits additional retransmissions of the message, legitimate vehicles (e.g., 454) may stop sending NACK messages as they are able to successfully decode a retransmission of the message. However, the attacker vehicle 456 will continue to transmit attacking NACK messages. Based on the transmission of the sufficient number of retransmissions, the vehicle 452 may identify NACK messages from the vehicle 456 as illegitimate or attack NACK message is. Further, the vehicle 452 may identify a direction from the vehicle 452 to the NACK attacker 456 based on an angle of arrival of the illegitimate NACK message(s). For example, the vehicle 452 may identify that the illegitimate NACK messages originate from quadrant 4. In some embodiments, the vehicle 452 may wait to receive at least two illegitimate NACK messages to confirm the presence of the attacker 456.

In some embodiments, the vehicle 452 may perform one or more operations to improve the accuracy of detection of attacking NACK messages. For example, the vehicle 452 may reduce an MCR used for (e.g., encoded in) retransmission messages. As noted above, the attacker vehicle 456 typically will transmit a NACK message even if the attacker vehicle 456 is located beyond the MCR. As another example, the vehicle 452 may transmit retransmission messages using a more robust modulation and coding scheme (MCS). Increasing the MCS may increase a robustness of the retransmitted messages, which may increase the likelihood that a legitimate vehicle may successfully decode a retransmitted message and not transmit a NACK message. In some embodiments, the vehicle 452 may determine whether to reduce the MCR and/or increase the MCS based on one or more aspects of the communication environment, such as the quantity of vehicles in the communication environment, local RF conditions, channel congestion, proximate topographical and/or road conditions, and/or other factors.

In some embodiments, the vehicle 452 may determine a receive signal strength (e.g., a Received Signal Strength Indicator (RSSI)) of the one or more received NACK messages to improve the detection of NACK attack messages. For example, in systems using connection-less groupcast, all NACK messages transmitted by various vehicles may be superimposed over the same physical sidelink feedback channel (PSFCH) symbol physical resource block (PRB). As the vehicle 452 retransmits the message, the vehicle 452 may determine a received signal strength of the NACK messages. As legitimate vehicles (e.g., 454) stopped transmitting NACK messages, the receive signal strength of NACK messages may decrease. When the only remaining received NACK messages are received from attacking vehicles, the vehicle 452 may determine that the received signal strength of NACK messages stabilizes. In this manner, the vehicle 452 may use the receive signal strength of the NACK messages to more rapidly identify the presence of a NACK attacker.

The vehicle 452 may perform an operation to mitigate adverse effects (e.g., inconvenient and unsafe impacts) of NACK messages received from the NACK attacker in response to determining that the NACK attacker is present. For example, the vehicle 452 may not retransmit messages in response to identified NACK attack messages. In some embodiments, the vehicle 452 may ignore or disregard NACK message is originating from the angular zone, arc or quadrant in which the NACK attacker is located. For example, the vehicle 452 may disregard NACK messages originating from quadrant 4.

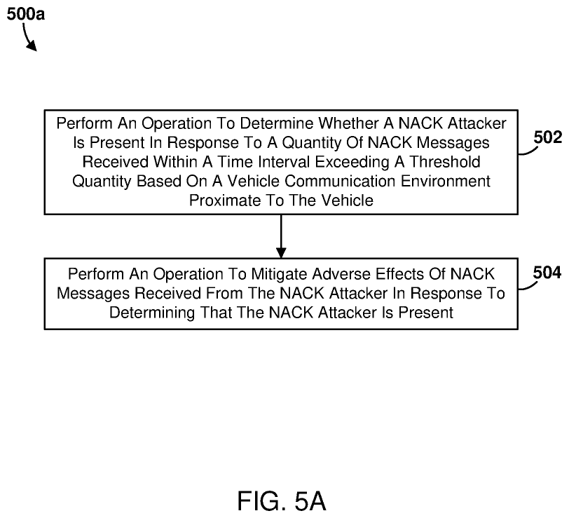

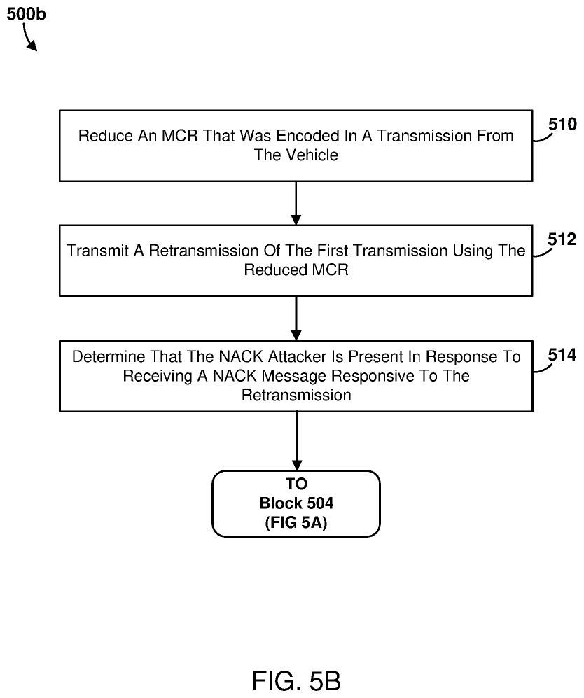

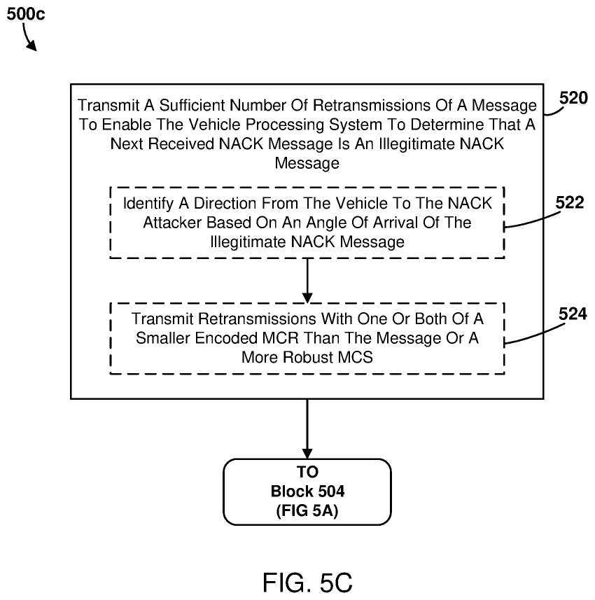

FIG. 5A is a process flow diagram of an example method 500a performed by a processor of a vehicle processing system for managing a NACK attack in accordance with various embodiments. With reference to FIGS. 1A-5A, means for performing the operations of the method 500a may include one or more processors (e.g., 207, 300) of a vehicle processing system (e.g., a V2X processing system) that may be implemented in hardware elements, software elements, or a combination of hardware and software elements, executing one or more of the modules 334-342. To encompass any of the processors, hardware elements, and software elements that may configured to perform operations of the method 500a, such elements or subsystems are referred to generally as a “processor.”

In block 502, the processor may perform an operation to determine whether a NACK attacker is present in response to a quantity of NACK messages received within a time interval exceeding a threshold quantity that is based on a vehicle communication environment proximate to the vehicle. In some embodiments, the threshold quantity of NACK messages may be based on a density of second vehicles proximate to the vehicle. In some embodiments, the threshold quantity of NACK messages may be based on a minimum communications range (MCR) encoded in a transmission from the vehicle. In some embodiments, the quantity of NACK messages received within the time interval may include a quantity of NACK messages received within a predetermined number of transport blocks (TBs). In some embodiments, the processor may including in one or more retransmissions of a message sent in response to received NACK messages a probe transport block that is configured to be smaller than a data-carrying transport block.

In block 504, the processor may perform an operation to mitigate adverse effects of NACK messages received from the NACK attacker in response to determining that the NACK attacker is present. For example, the processor may not transmit a retransmission of a message in response to receiving a NACK message from the NACK attacker. For example, the processor may ignore or disregard a NACK message received from the NACK attacker.

FIG. 5B is a process flow diagram of example operations 500b that may be performed by a processor of a vehicle processing system as part of the method 500a for managing a NACK attack in accordance with various embodiments. With reference to FIGS. 1A-5B, means for performing the operations 500b may include one or more processors (e.g., 207, 300) of a vehicle processing system (e.g., a V2X processing system) that may be implemented in hardware elements, software elements, or a combination of hardware and software elements, executing one or more of the modules 334-342. To encompass any of the processors, hardware elements, and software elements that may configured to perform the operations 500b, such elements or subsystems are referred to generally as a “processor.”

In block 510, the processor may reduce an MCR that was encoded in a transmission from the vehicle. In some embodiments, the processor may reduce the MCR to confirm whether a NACK attack is occurring in response to an indication that a NACK attacker is present, such as in response to the quantity of NACK messages received within a time interval exceeding a threshold quantity. In some embodiments, the processor may reduce the MCR by a first amount in response to determining that a CBR meets a CBR threshold. In some embodiments, the processor may reduce the MCR by a second amount that is less than the first amount in response to determining that the CBR does not meet the CBR threshold.

In block 512, the processor may transmit a retransmission of the first transmission using the reduced MCR.

In block 514, the processor may confirm (i.e., determine) that the NACK attacker is present in response to receiving a NACK message responsive to the retransmission sent with the reduced MCR.

The processor may perform an operation to mitigate adverse effects of NACK messages received from the NACK attacker in response to determining that the NACK attacker is present in block 504 as described.

FIG. 5C is a process flow diagram of example operations 500c that may be performed by a processor of a vehicle processing system as part of the method 500a for managing a NACK attack in accordance with various embodiments. With reference to FIGS. 1A-5C, means for performing the operations 500c may include one or more processors (e.g., 207, 300) of a vehicle processing system (e.g., a V2X processing system) that may be implemented in hardware elements, software elements, or a combination of hardware and software elements, executing one or more of the modules 334-342. To encompass any of the processors, hardware elements, and software elements that may configured to perform the operations 500c, such elements or subsystems are referred to generally as a “processor.”

In block 520, the processor may transmit a sufficient number of retransmissions of a message to enable the vehicle processing system to determine that a next received NACK message is an illegitimate NACK message. For example, the processor may transmit a sufficient number of retransmissions of a message such that most or all legitimate vehicles will not transmit a NACK message responsive to a retransmission. After transmitting a sufficient number of retransmissions, the processor may determine that a next received NACK message is an illegitimate (or attack) NACK message.

In optional block 522, the processor may identify a direction from the vehicle to the NACK attacker based on an angle of arrival of illegitimate NACK messages. For example, the processor may identify an angular zone, directional arc or quadrant in which the NACK attacker is located based on the direction from which the illegitimate NACK message was received.

In optional block 524, the processor may transmit retransmissions of the message with one or both of a smaller encoded MCR than the (initial, original, first) message or a more robust (increased, higher) MCS. Doing so may enable the processor to confirm a NACK attack based on whether NACK requests continue to be received regardless of the robustness of the MCS used in retransmissions.

The processor may perform an operation to mitigate adverse effects of NACK messages received from the NACK attacker in response to determining that the NACK attacker is present in block 504 as described.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods and operations 400, 450, and 500a-500c may be substituted for or combined with one or more operations of the methods or operations 400, 450, and 500a-500c.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a vehicle processing system for managing a non-acknowledgement message (NACK) attack, including: performing an operation to determine whether a NACK attacker is present in response to a quantity of NACK messages received within a time interval exceeding a threshold quantity that is based on a vehicle communication environment proximate to the vehicle; and performing an operation to mitigate adverse effects of NACK messages received from the NACK attacker in response to determining that the NACK attacker is present.

Example 2. The method of example 1, in which the threshold quantity is based on a density of second vehicles proximate to the vehicle.

Example 3. The method of either of examples 1 or 2, in which the quantity of NACK messages received within the time interval includes a quantity of NACK messages received within a predetermined number of transport blocks (TBs).

Example 4. The method of any of examples 1-3, in which the threshold quantity is based on a minimum communications range (MCR) encoded in a transmission from the vehicle.

Example 5. The method of any of examples 1-4, in which performing an operation to determine whether a NACK attacker is present includes: reducing an MCR that was encoded in a transmission from the vehicle; retransmitting the first transmission using the reduced MCR; and confirming that the NACK attacker is present in response to receiving a NACK message responsive to the retransmission.

Example 6. The method of example 5, in which reducing the MCR that was encoded in a transmission from the vehicle includes: reducing the MCR by a first amount in response to determining that a channel busy ratio (CBR) meets a CBR threshold; and reducing the MCR by a second amount that is less than the first amount in response to determining that the CBR does not meet the CBR threshold.

Example 7. The method of any of examples 1-6, in which performing an operation to determine whether a NACK attacker is present includes transmitting a sufficient number of retransmissions of a message to enable the vehicle processing system to determine that a next received NACK message is an illegitimate NACK message.

Example 8. The method of example 7, further including identifying a direction from the vehicle to the NACK attacker based on an angle of arrival of the illegitimate NACK message.

Example 9. The method of either of example 7 or example 8, in which retransmissions of the message are transmitted with one or both of a smaller encoded MCR than the message or a more robust modulation and coding scheme (MCS).

Example 10. The method of any of examples 1-9, in which performing an operation to determine whether a NACK attacker is present includes including in one or more retransmissions of a message sent in response to received NACK messages a probe transport block that is configured to be smaller than a data-carrying transport block.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a vehicle processing system for managing a non-acknowledgement message (NACK) attack, comprising:
performing an operation to determine whether a NACK attacker is present in response to a quantity of NACK messages received within a time interval exceeding a threshold quantity that is based on a vehicle communication environment proximate to the vehicle; and
performing an operation to mitigate adverse effects of NACK messages received from the NACK attacker in response to determining that the NACK attacker is present.

2. The method of claim 1, wherein the threshold quantity is based on a density of second vehicles proximate to the vehicle.

3. The method of claim 1, wherein the quantity of NACK messages received within the time interval comprises a quantity of NACK messages received within a predetermined number of transport blocks (TBs).

4. The method of claim 1, wherein the threshold quantity is based on a minimum communications range (MCR) encoded in a transmission from the vehicle.

5. The method of claim 1, wherein performing an operation to determine whether a NACK attacker is present comprises:
reducing an MCR that was encoded in a transmission from the vehicle;
retransmitting the first transmission using the reduced MCR; and
confirming that the NACK attacker is present in response to receiving a NACK message responsive to the retransmission.

6. The method of claim 5, wherein reducing the MCR that was encoded in a transmission from the vehicle comprises:
reducing the MCR by a first amount in response to determining that a channel busy ratio (CBR) meets a CBR threshold; and
reducing the MCR by a second amount that is less than the first amount in response to determining that the CBR does not meet the CBR threshold.

7. The method of claim 1, wherein performing an operation to determine whether a NACK attacker is present comprises transmitting a sufficient number of retransmissions of a message to enable the vehicle processing system to determine that a next received NACK message is an illegitimate NACK message.

8. The method of claim 7, further comprising identifying a direction from the vehicle to the NACK attacker based on an angle of arrival of the illegitimate NACK message.

9. The method of claim 7, wherein retransmissions of the message are transmitted with one or both of a smaller encoded MCR than the message or a more robust modulation and coding scheme (MCS).

10. The method of claim 1, wherein performing an operation to determine whether a NACK attacker is present comprises including in one or more retransmissions of a message sent in response to received NACK messages a probe transport block that is configured to be smaller than a data-carrying transport block.

11. A processing system for a vehicle, comprising:
a wireless transceiver; and
a processor coupled to the wireless transceiver and configured with processor-executable instructions to:
perform an operation to determine whether a non-acknowledgement message (NACK) attacker is present in response to a quantity of NACK messages received within a time interval exceeding a threshold quantity that is based on a vehicle communication environment proximate to the vehicle; and
perform an operation to mitigate adverse effects of NACK messages received from the NACK attacker in response to determining that the NACK attacker is present.

12. The processing system of claim 11, wherein the threshold quantity is based on a density of second vehicles proximate to the vehicle.

13. The processing system of claim 11, wherein the quantity of NACK messages received within the time interval comprises a quantity of NACK messages received within a predetermined number of transport blocks (TBs).

14. The processing system of claim 11, wherein the threshold quantity is based on a minimum communications range (MCR) encoded in a transmission from the vehicle.

15. The processing system of claim 11, wherein the processor is further configured with processor-executable instructions to perform an operation to determine whether a NACK attacker is present by:
reducing an MCR that was encoded in a transmission from the vehicle;
retransmitting the first transmission using the reduced MCR; and
confirming that the NACK attacker is present in response to receiving a NACK message responsive to the retransmission.

16. The processing system of claim 15, wherein the processor is further configured with processor-executable instructions to reduce the MCR that was encoded in a transmission from the vehicle by:
reducing the MCR by a first amount in response to determining that a channel busy ratio (CBR) meets a CBR threshold; and
reducing the MCR by a second amount that is less than the first amount in response to determining that the CBR does not meet the CBR threshold.

17. The processing system of claim 11, wherein the processor is further configured with processor-executable instructions to perform an operation to determine whether a NACK attacker is present by transmitting a sufficient number of retransmissions of a message to enable the vehicle processing system to determine that a next received NACK message is an illegitimate NACK message.

18. The processing system of claim 17, wherein the processor is further configured with processor-executable instructions to identify a direction from the vehicle to the NACK attacker based on an angle of arrival of the illegitimate NACK message.

19. The processing system of claim 17, wherein the processor is further configured with processor-executable instructions to retransmit the message with one or both of a smaller encoded MCR than the message or a more robust modulation and coding scheme (MCS).

20. The processing system of claim 11, wherein the processor is further configured with processor-executable instructions to perform an operation to determine whether a NACK attacker is present including in one or more retransmissions of a message sent in response to received NACK messages a probe transport block that is configured to be smaller than a data-carrying transport block.

21. A vehicle processing system for a vehicle, comprising:
performing an operation to determine whether a non-acknowledgement message (NACK) attacker is present in response to a quantity of NACK messages received within a time interval exceeding a threshold quantity that is based on a vehicle communication environment proximate to the vehicle; and
performing an operation to mitigate adverse effects of NACK messages received from the NACK attacker in response to determining that the NACK attacker is present.

22. The processing system of claim 21, wherein the threshold quantity is based on a density of second vehicles proximate to the vehicle.

23. The processing system of claim 21, wherein the quantity of NACK messages received within the time interval comprises a quantity of NACK messages received within a predetermined number of transport blocks (TBs).

24. The processing system of claim 21, wherein the threshold quantity is based on a minimum communications range (MCR) encoded in a transmission from the vehicle.

25. The processing system of claim 21, wherein performing an operation to determine whether a NACK attacker is present comprises:
reducing an MCR that was encoded in a transmission from the vehicle;
retransmitting the first transmission using the reduced MCR; and
confirming that the NACK attacker is present in response to receiving a NACK message responsive to the retransmission.

26. The processing system of claim 25, wherein reducing the MCR that was encoded in a transmission from the vehicle comprises:
reducing the MCR by a first amount in response to determining that a channel busy ratio (CBR) meets a CBR threshold; and
reducing the MCR by a second amount that is less than the first amount in response to determining that the CBR does not meet the CBR threshold.

27. The processing system of claim 21, wherein performing an operation to determine whether a NACK attacker is present comprises transmitting a sufficient number of retransmissions of a message to enable the vehicle processing system to determine that a next received NACK message is an illegitimate NACK message.

28. The processing system of claim 27, further comprising identifying a direction from the vehicle to the NACK attacker based on an angle of arrival of the illegitimate NACK message.

29. The processing system of claim 7, wherein retransmissions of the message are transmitted with one or both of a smaller encoded MCR than the message or a more robust modulation and coding scheme (MCS).

30. A non-transitory processor-readable medium having stored thereon processor-executable instructions configured to cause a processor of a vehicle processing system to perform operations comprising:
performing an operation to determine whether a non-acknowledgement message (NACK) attacker is present in response to a quantity of NACK messages received within a time interval exceeding a threshold quantity that is based on a vehicle communication environment proximate to the vehicle; and
performing an operation to mitigate adverse effects of NACK messages received from the NACK attacker in response to determining that the NACK attacker is present.
